(19) United States
(12) Patent Application Publication
(10) Pub. No.: US 2025/0077843 A1
(43) Pub. Date: Mar. 6, 2025

(54) SYSTEM AND METHOD FOR BEHAVIOR ANALYSIS

(71) Applicant: TOMOFUN CO., LTD., Taipei City (TW)

(72) Inventors: Yu Chen CHANG, Taipei City (TW); Chia-Yen CHANG, Taipei City (TW); Nuo-Pai HSU, Taipei City (TW); Ping-I CHOU, Taipei City (TW)

(21) Appl. No.: 18/520,914

(22) Filed: Nov. 28, 2023

(30) Foreign Application Priority Data
Sep. 6, 2023 (TW) 112133792

(51) Int. Cl. G06N 3/0455; G06N 3/042; G06N 3/0475

(52) U.S. Cl. CPC G06N 3/0455; G06N 3/042; G06N 3/0475

(57) ABSTRACT

A behavior analysis system, comprising: a first electronic device configured to capture image data of a scene to obtain a first monitoring message; a computing unit, in communication with the first electronic device, comprising: an artificial intelligence module configured to receive the first monitoring message and detect a first behavior event from the first monitoring message; an event aggregation module configured to aggregate the first behavior event to generate an event aggregation report; and a language model configured to generate a behavior summary based on the event aggregation report; and a user equipment, in communication with the first electronic device and the computing unit, configured to display the behavior summary; wherein the behavior summary is in a form of natural language.

### CROSS-REFERENCE

This application claims the priority benefit of Taiwan application serial no. 112133792, filed on Sep. 6, 2023. The entirety of the above-mentioned patent application is hereby incorporated by reference herein and made a part of this specification.

### TECHNICAL FIELD

The present disclosure relates to systems and methods for behavior analysis, and particularly, to systems and methods for pet behavior analysis.

### BACKGROUND

Existing techniques allow pet owners to monitor their household pets via remote camera devices or obtain real-time locations, activity status, etc., of their pets, via wearable devices while the pet owners are apart from their pets. However, it is not possible for pet owners to constantly watch the monitoring videos or read monitoring messages. Thus, pet owners may not have a good grasp of overall activity status of pets, and often miss important monitoring videos and messages.

Existing pet monitoring techniques mostly notify specific events of pets, rather than provide a comprehensive summary of activity status of pets based on the videos captured from remote camera devices. Pet owners still need to review and annotate the videos by themselves, and manually generate textual records for the convenience of subsequent rewind and retrieval. Therefore, monitoring pets through existing techniques suffers from drawbacks including being time-consuming and inefficient.

While wearable devices for pets may provide detailed physiological data, pet owners still need to rely on auxiliary information to comprehend the cause of such a measured result of the physiological data. For example, the physiological data may indicate that the pet was under emotional stress at a certain time, the pet owner speculated on the cause of the emotional stress with the help of video data or further auxiliary data, so as to take appropriate countermeasures.

Therefore, how the pet owner can quickly and conveniently understand the situations of their pets when the pets are left alone is still a problem to be solved.

### SUMMARY OF THE INVENTION

In order to solve the above-mentioned problems, the present disclosure provides systems and methods for behavior analysis, which utilize pet behavior videos and/or pet sensor messages for pet behavior analysis, and automatically generate a behavior summary and provide a corresponding behavior suggestion. The behavior summary and the behavior suggestion are presented to pet owners in a form of natural language, thereby facilitating pet owners to better understand their pets' behaviors, and saving their time and energy in browsing for videos and sensor messages.

An embodiment of the disclosure is a behavior analysis system, comprising: a first electronic device configured to capture image data of a scene to obtain a first monitoring message; a computing unit, in communication with the first electronic device, comprising: an artificial intelligence module configured to receive the first monitoring message and detect a first behavior event from the first monitoring message; an event aggregation module configured to aggregate the first behavior event to generate an event aggregation report; and a language model configured to generate a behavior summary based on the event aggregation report; and a user equipment, in communication with the first electronic device and the computing unit, configured to display the behavior summary; wherein the behavior summary is in a form of natural language.

Another embodiment of the disclosure is a behavior analysis method, executed by a computing unit, comprising: receiving a first monitoring message via capturing image data of a scene from a first electronic device; detecting a first behavior event from the first monitoring message; aggregating the first behavior event to generate an event aggregation report; generating a behavior summary based on the event aggregation report; and transmitting the behavior summary to a user equipment; wherein the behavior summary is in a form of natural language.

As introduced above, the advantages and benefits of the technical solution of the present disclosure will become apparent compared with the prior art. The behavior analysis systems and methods of the present disclosure facilitate understanding behavior status of pets during a certain period of time through a behavior summary automatically generated by artificial intelligence models in combination with language models, relieving pet owners of tediously reviewing behavior videos and sensor messages, and achieving beneficial effects of convenience and expeditiousness in understanding pet behavior. Preferably, the pet owner may further review relevant video clips from the behavior event links provided in the behavior summary, obtain corresponding behavior suggestions and interact with the system through prompts, thereby enhancing user experience.

### BRIEF DESCRIPTION OF THE DRAWINGS

FIG. 1 is a block diagram of a behavior analysis system according to an embodiment of the present disclosure.

FIG. 2 is a schematic diagram of computing unit according to an embodiment of the present disclosure.

FIG. 3 is a schematic diagram of a user interface of a behavior analysis system according to an embodiment of the present disclosure.

FIG. 4 is a flowchart of a behavior analysis method according to an embodiment of the present disclosure.

FIG. 5 is another flowchart of a behavior analysis method according to another embodiment of the present disclosure.

### DETAILED DESCRIPTION

The features and advantages in embodiments of the present disclosure will be described in detail as follows, and thus it is sufficient for a person skilled in the art to understand the technical contents of the present disclosure and implement thereof. In particular, a person skilled in the art can easily understand the objects and advantages of the present disclosure by referring to the disclosure of the specification, the claims, and the accompanying drawings.

It should be understood that the terms “include” and “comprise” as well as derivatives thereof, as used herein are to indicate the existence of specific technical features, values, steps, operations, and components, but not to exclude other possible technical features, values, steps, operations, and components or any combination thereof. Moreover, it should be understood that the singular forms “a,” “an,” and “the” include plural referents unless the context clearly dictates otherwise.

Ordinal terms such as “first,” “second,” “third,” etc., are used merely as labels to distinguish elements with the same name in the present disclosure and should not be construed as indicating any priority, precedence, the order of one element over another, the temporal order in which acts of a method are performed, the temporal order in which instructions executed by a device are performed, etc.

When referring to a first element being “connected” to a second element, it should be interpreted that not only can the first element be “directly connected” to the second element, but a third element can also be “inserted” between the first element and the second element, or the first element and the second element may be “connected” to each other through a fourth element, and so on. The second element as used herein may include at least one of two or more elements “connected” to each other or the like.

The steps of the methods described in present disclosure may be adjusted based on an actual demand and may be executed concurrently or partially concurrently unless the context explicitly specified otherwise. In addition, it will be understood that various omissions, substitutions, and modification may be adaptively made to the steps among different embodiments.

The term “unit” as used herein may refer to a computer-related entity, hardware, firmware, software, and combinations thereof. A unit, given by way of illustration and not of limitation, may be a procedure running on a processor, a processor, a thread, and/or a computer. For example, an application running on a computing device and a computing device may both be a unit. In an embodiment of the present disclosure, the units may be stored in a local computer, or may be stored in multiple computers in a distributed manner. Multiple units may communicate with each other through the network.

The term “module” as used herein may describe the functionality of a given unit that may be performed in accordance with one or more implementations of the present disclosure. As used herein, a module may be implemented in any form of hardware, software, or a combination thereof. For example, one or more processors, controllers, logic components, software programs, or other mechanisms may be implemented to form a module. In accordance with embodiments of the present disclosure, the various modules may be implemented as discrete modules, or the functions and features described may be partially or fully shared among one or more modules. Although various features or elements of functionality may be described or claimed as separate modules, a person skilled in the art will understand that such features and functions may be shared between one or more software and hardware elements, and such descriptions do not require or imply that separate hardware or software components are used to implement such features or functions.

Aspects and advantages of the present disclosure will become apparent from the following detailed description taken in conjunction with the accompanying drawings which illustrate, by way of example, the principles of the described embodiments.

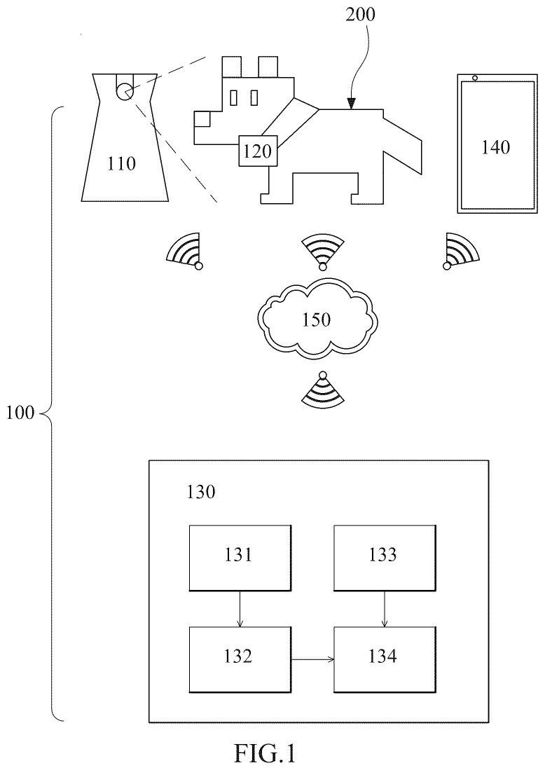

Referring to FIG. 1, the behavior analysis system 100 comprises a first electronic device 110, a second electronic device 120, a computing unit 130, and a user equipment 140, wherein the computing unit 130 is in communication with the first electronic device 110, the second electronic device 120 and the user equipment 140 through a network 150.

In an embodiment, the first electronic device 110 may be implemented as any electronic device capable of capturing images and/or videos of a scene to obtain a first monitoring message and communicating with the computing unit 130. The first electronic device 110 is positioned in the scene, which may be an indoor space of the pet owner's house, an indoor space of the pet hotel, and the like. In another embodiment, the first electronic device 110 may further collect sounds of the pet 200 and output voices of a remote user. In another embodiment, the first electronic device 110 may also toss a treat or toy to interact with the pet 200. The first electronic device 110 transmits the first monitoring message including at least one of image data, video data, audio data, interactive data and other pet-related data to the computing unit 130 through the network 150.

In an embodiment, the behavior analysis system 100 may further comprise a second electronic device 120 to sense motion data of pet 200 to obtain a second monitoring message of the pet 200. The second electronic device 120 may be implemented as any electronic device worn by the pet 200 or implanted within the pet 200 for sensing motion data, physiological data, activity data of the pet 200 or environmental data of an environment in which the pet 200 is located and communicating with the computing unit 130. The second electronic device 120 may be in the form of a collar, an ankle collar, a harness, socks, shoes, a leash, a vest, a backpack and the like. In an embodiment, the second electronic device 120 may comprise one or more sensors including at least one Inertial Measurement Unit (IMU) for providing motion data regarding motion direction, motion speed and the like. In an embodiment, the one or more sensors may further include, but not limit to a body temperature sensor, a heart rate sensor, a respiration sensor, a skin impedance sensor, a galvanic skin response (GSR) sensor, an electrocardiogram sensor, a pulse sensor, a gravity sensor and the like. Correspondingly, the second monitoring message may include motion data, body temperature sensing data, heart rate sensing data, respiration sensing data, skin impedance sensing data, GSR sensing data, electrocardiogram sensing data, pulse sensing data, gravity sensing data and the like. The second electronic device 120 may transmit the second monitoring message to the computing unit 130 through the network 150.

In some embodiments, the first electronic device 110 and the second electronic device 120 are edge devices capable of providing edge computing services. In contrast to centralized cloud computing, edge computing utilizes a decentralized network computing architecture. Edge computing performs real-time data processing and data analyzing via external or embedded computing devices placed close to the data source or terminal, which implies that data is processed in positions close to where the data is generated so as to reduce latency and lower bandwidth demands. The edge device may be an Internet of Things (IoT) device such as a smart camera, a smart watch, smart glasses, a smart speaker, and the like. In an embodiment, the first electronic device 110 may include an image recognition function for identifying whether the captured images, videos and/or audio comprises at least one motion and/or at least one sound a motion; the second electronic device 120 may include a data processing function to determine whether the second monitoring message comprises at least one motion and/or at least one sound. Accordingly, the determination that whether the first and/or second monitoring message comprises at least one motion and/or at least one sound is performed at the first electronic device 110 and/or the second electronic device 120, which are the sources of the monitoring messages. In response to a determination that the monitoring messages contain at least one motion and/or at least one sound, the monitoring messages are transmitted to the computing unit 130. By performing preliminary data processing at data sources, namely, performing the determination at the first electronic device 110 and the second electronic device 120, and sending the most relevant monitoring messages to the computing unit 130 for further data computation and analysis, there may be a reduced risk of data interception and improvement of secure data transmission. Therefore, effectively reducing network delay and computation load of the computing unit 130 and increasing response speed of the system can be expected.

In an embodiment, the pet 200 may be a dog, a cat, or other animals.

The computing unit 130 communicates with the first electronic device 110, the second electronic device 120, and the user equipment 140 through the network 150. The network 150 may be, for example, a local area network, a wide area network, a wireless wide area network, a circuit switched telephone network, a global system for mobile communication (GSM) network, a wireless application protocol (WAP) network, a WiFi network, an IEEE 802.11 standard network, and various combinations thereof. Other networks may also be used without departing from the spirit or scope of the present disclosure.

In an embodiment, the computing unit 130 may be any electronic or computer device having a processor for executing instructions and capable of communicating via the network 150. The computing unit 130 may also include one or more storage devices, such as a random-access memory (RAM), a read-only memory (ROM), an electrically erasable programmable ROM (EEPROM), an optical disk storage, a magnetic disk storage, other magnetic storage devices, combinations of the types of storage devices, or any other storage devices that may be used to store data needed to be stored during computing process. In the embodiments described in the present disclosure, the computing unit 130 providing computing services may be a tablet computer, a notebook computer, a desktop computer, a network server, a cloud computing platform and the like, and the computing unit 130 may be implemented as any variant of the above listed examples per user demand.

In an embodiment, the computing unit 130 comprises an artificial intelligence module 131, an event aggregation module 132, a knowledge module 133, and a language module 134.

In an embodiment, the computing unit 130 is configured to receive the first monitoring message from the first electronic device 110 and the second monitoring message from the second electronic device 120. After receiving the first monitoring message and the second monitoring message, the artificial intelligence module 131 detects a first behavior event from the first monitoring message and detects a second behavior event from the second monitoring message respectively. In an embodiment, the first electronic device 110 determine whether the first monitoring message comprises at least one motion and/or at least one sound and the second electronic device 120 determine whether the second monitoring message comprises at least one motion and/or at least one sound. Specifically, the first electronic device 110 and the second electronic device 120 perform motion detection and sound detection and then send the first monitoring message and the second monitoring message comprising at least one motion and/or at least one sound to the computing unit 130. Next, the artificial intelligence module 131 of the computing unit 130 further determines whether the at least one motion and/or the at least one sound in the first monitoring message and/or the second monitoring message is associated with a target object, wherein the target object includes the pet 200 or a person. In other words, the artificial intelligence module 131 of the computing unit 130 determines whether the first monitoring message and/or the second monitoring message comprises at least one motion and/or at least one sound associated with the pet 200 or a person. In response to the determination that the first monitoring message and/or the second monitoring message comprising at least one motion and/or at least one sound associated with the pet 200 or a person, the artificial intelligence module 131 proceeds to detect behavior events from the first monitoring message and the second monitoring message. Alternatively, the first electronic device 110 and the second electronic device 120 do not determine whether the first monitoring message and the second monitoring message comprise at least one motion and/or at least one sound, and send all the monitoring messages to the computing unit 130. The computing unit 130 determines whether the first monitoring message and/or the second monitoring message comprise at least one motion and/or at least one sound. In response to the determination that the first monitoring message and/or the second monitoring message comprise at least one motion and/or at least one sound, the computing unit 130 further determines whether the at least one motion and/or the at least one sound in the first monitoring message and/or the second monitoring message is associated with the target object. In response to the at least one motion and/or the at least one sound in the first monitoring message and/or the second monitoring message being associated with the target object, the artificial intelligence module 131 detects the first behavior event from the first monitoring message and the second behavior event from the second monitoring message, respectively.

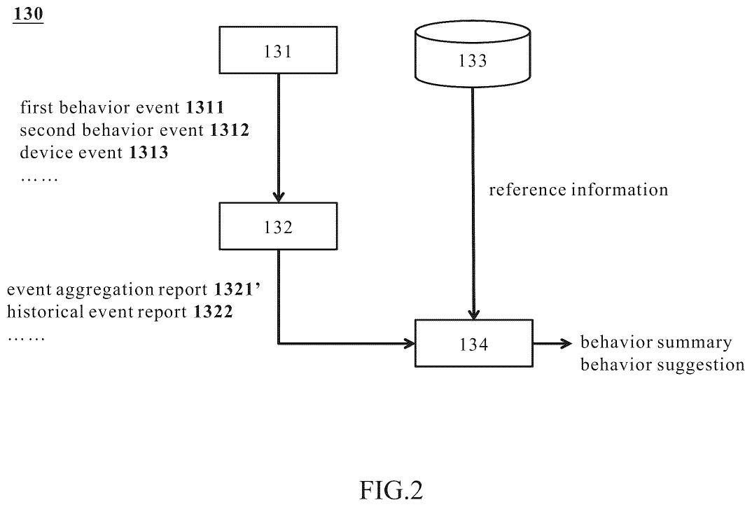

Continuing with reference to FIG. 1 and FIG. 2, in an embodiment, after receiving the first monitoring message from the first electronic device 110, the artificial intelligence module 131 detects a first behavior event 1311 from the first monitoring message; after receiving the second monitoring message, the artificial intelligence module 131 detects a second behavior event 1312 from the second monitoring message, wherein the first behavior event 1311 and the second behavior event 1312 include one or more behavior events.

In another embodiment, the artificial intelligence module 131 may determine whether to notify the user of the behavior events included in the first behavior event 1311 and the second behavior event 1312, and/or display them in an event list. If it is determined to notify the user of the behavior events, a cloud recording mechanism may be triggered to record videos related to the events and the videos are stored on the computing unit 130 or any other suitable storage. Users may watch the videos through links in an event list shown on a user interface.

Behavior events in the first behavior event 1311 and the second behavior event 1312 may be detected in various ways. In an embodiment, the artificial intelligence module 131 may utilize an image-to-text model and/or a video-to-text model to detect behavior events. The image-to-text model and/or the video-to-text model may render descriptive sentences based on images and videos. For example, the models may identify objects, classify objects, and generate textual content containing subjects, verbs, and locations on the basis of models' descriptive ability of the objects and thus behavior events are detected correspondingly. For example, the artificial intelligence module 131 uses the image-to-text model and/or the video-to-text model to detect behavior events such as eating, biting, excreting, running, vomiting and the like.

In an embodiment, the artificial intelligence module 131 may detect behavior events utilizing a motion recognition model, a pet sound recognition model, and an environmental sound recognition model. The artificial intelligence module 131 utilizes the motion recognition model to identify a motion of the pet 200 or a person from the videos. The artificial intelligence module 131 may also utilize the pet sound recognition model to identify the barking, continuous barking, howling, whining and the like of the pet 200, and utilize the environmental sound recognition model to identify an earthquake siren sound, a fire siren sound, a sound of glass breaking, a thunder sound, and other environmental sounds collected in the environment where the pet 200 is located. It should be understood that different sound thresholds for different sound targets are based on volumes of sounds detected.

In an embodiment, the artificial intelligence module 131 may include a sensing data recognition model to detect behavior events. The sensing data recognition model may identify the behaviors, postures, locations and the like of the pet 200 based on the motion data, body temperature sensing data, heart rate sensing data, respiration sensing data and the like in the second monitoring message. For example, the sensing data recognition model may recognize a long-term event, a noteworthy event, an emergency event and the like of the pet 200, and the long-term event may be a low-intensity activity (e.g., sitting, standing, resting, etc.), a high-intensity activity and the like; the noteworthy event may be eating, drinking, scratching, licking, tachypnea and the like; the emergency event may be vomiting, convulsion, apnea and the like.

The first behavior event 1311 and the second behavior event 1312 each comprise a combination of one or more precise behavior events and one or more non-precise behavior events, wherein the precise behavior events are events with predefined event types. Specifically, the artificial intelligence module 131 may predefine the event types on the basis of importance levels, attention levels, predicted attention levels of the events and match the detected behavior events with predefined event types. The detected behavior events are precise behavior events if they are matched with predefined event types; otherwise, the detected behavior events are non-precise behavior events. In other words, precise behavior events are events with predefined event types. Therefore, the amount of non-precise behavior events is generally greater than that of precise behavior events, while the classification accuracy of non-precise behavior events is generally lower than that of precise behavior events.

In an embodiment, the event aggregation module 132 is used to combine and simplify events from various sources and with diverse types, so as to generate an event aggregation report 1321 easily understood by the language module 134. The event aggregation module 132 may include various components for information aggregation. For example, the event aggregation module 132 may include an information cache component, an information aggregator component, an information transformation component, information mapping component and/or a service router.

Specifically, the pet 200 may have the same or similar behaviors at different times. Therefore, one or more behavior events in the first behavior event 1311 may be related to each other; one or more behavior events in the second behavior event 1312 may be related to each other. Furthermore, the first electronic device 110 and the second electronic device 120 obtain behavior information of the pet 200 in different aspects, and thus obtain different behavior information for the same behavior of the pet 200 at the same time. Therefore, one or more behavior events in the first behavior event 1311 detected from the first monitoring message and the second behavior event 1312 detected from the second monitoring message may be related to each other. The event aggregation module 132 may aggregate these related events by means of translating error codes, status codes, device identification codes and the like in the first behavior event 1311 and the second behavior event 1312 into textual contents easily comprehensible by the language module 134. In addition, the event aggregation module 132 may perform noise filtering, event sorting and information simplifying based on spatial-based conditions, temporal-based conditions, action-based conditions, identifier-based conditions, etc. In addition, the one or more behavior events may be marked with notability levels. For example, a vomiting event may be marked with three stars, and a heavy rain event may be marked with one star, wherein a quantity of stars is proportional to the notability level. The event aggregation module 132 may convert event information from different sources and of different formats into a more abstract representation of information, thereby generating an event aggregation report 1321 easily comprehended and processed by the language module 134, wherein the event aggregation report 1321 may be in the form of semi-structured information.

Referring to FIG. 2, the event aggregation module 132 may aggregate events from different sources. In an embodiment, the event aggregation module 132 aggregates the first behavior event 1311 and the second behavior event 1312 to generate the event aggregation report. In another embodiment, the event aggregation module 132 may also aggregate the device event 1313 including power on/off status, network status, and schedule setting status, image setting status and the like of the first electronic device 110 and the second electronic device 120. In another embodiment, the event aggregation module 132 may further aggregate user events (not shown) including video watching logs, feeding logs and so on collected from the user equipment 140. In yet another embodiment, the event aggregation module 132 may further obtain environmental events (not shown) including weather information, earthquake information, fire warning information and the like based on the geographic locations of the first electronic device 110 and the second electronic device 120. The event aggregation module 132 may aggregate one or more of the first behavior event 1311, the second behavior event 1312, the device event 1313, the user event, the environment events and the like to generate an event aggregation report 1321.

In an embodiment, the event aggregation report 1321 is an aggregation result of all events within a predetermined time period, for example, an aggregation result of events happened in a single day, an aggregation result of events happened from 9 am to 6 μm of a day, and so on. In a preferred embodiment, the event aggregation module 132 may also generate an event aggregation report 1321′ including a historical event report 1322. The historical event report 1322 is a comparison result between the event aggregation report 1321′ and an event aggregation report of preset duration. For example, the event aggregation report 1321′ is a one-day event aggregation result, and the event aggregation module 132 may compare the one-day event aggregation result of the event aggregation report 1321′ with the event aggregation reports of the previous three days, last week or last month so as to generate a historical event report 1322. For example, historical event report 1322 may be, but not limit to, “Today's activity level is 18% higher than yesterday's activity level, 3% lower than last week's average activity level . . . ” In view of the foregoing description, the contents set forth in the historical event report 1322 may be briefer and more simplified than those set forth in the event aggregation report 1321′.

In an embodiment, the knowledge module 133 is in communication with the language module 134 and serves as another input source to the language module 134. The knowledge module 133 may adopt one or more databases or memory storage technologies, and non-limiting examples thereof include relational database, non-relational database, in-memory database, memory register, etc.

The knowledge module 133 may store reference information regarding pet profiles, professional knowledge, fundamental knowledge and the like from various sources. The knowledge module 133 may provide the reference information to the language module 134. The reference information stored knowledge module 133 may include pet behavior information, pet medical information, pet basic information, pet statistical information, etc., wherein the pet behavior information and pet medical information are knowledge base built in advance by retrieving related information from external information databases. Pet profiles are information of the pet 200 such as breed, age, sex, weight, length, height and the like input by the user, and pet statistical information, functioning as reference baselines, is the statistical data collected from all pets in the behavior analysis system 100.

In an embodiment, the language module 134 is a natural language processing model, and the language module 134 may be a Large Language Model, which is used to generate coherent and reasonable textual contents based on a given context, and perform tasks such as translating, coding, question answering, summarizing, text generating, math problems solving, logical reasoning, etc. In an embodiment, the language module 134 may analyze the pet's behavior based on the received event aggregation report 1321 and generate a behavior summary. Preferably, the language module 134 may also analyze the pet's behavior and generate a summary of the behavior based on the reference information provided by knowledge module 133 and the event aggregation report 1321.

The language module 134 may be, for example, a Generative Pre-trained Transformer (GPT), Generalist Language Model (GLaM), a Language Models for Dialog Applications (LaMDA), Large Language Model Meta AI (LLaMA), etc. It is understood that the foregoing examples are merely possible implementations and are not intended to be limiting. Any suitable large language model and version thereof could be adapted per design requirement.

In an embodiment, the event aggregation report 1321 generated by the event aggregation module 132 contains a large number of behavior events, and the language module 134 may perform behavior comprehension, behavior integration and behavior analysis before generating a behavior summary, where the behavior summary is in a form of natural language with an unstructured information format. The behavior summary may include one or more of the following, but is not limited to: (1) summary of activity in a day: “Exercising vigorously on the couch for about 30 minutes in the morning; mostly sleeping on the mattress in the afternoon”; (2) summary of notable events: “Vomited on the carpet once in the morning; glass shattering sound detected in the afternoon”; (3) summary of historical comparison: “Pet 200 drank less water today than the previous two days; activity level declined slowly this month”; (4) summary based on fundamental knowledge: “The possible reason for pet 200 vomiting today may be that its activity level is 60% more than dogs of the same breed”; (5) summary of user events: “You have interacted with pet 200 much more times today, pet 200's activity level increased by 20%, and drank 30% more water than yesterday”; (6) summary of device events: “Network connection of the first electronic device 110 was not stable today, the complete record is thus not available”; (7) summary of environmental events: “Today is extremely hot. Pet 200's activity level has been reduced by 50%, and tomorrow will be a hot day as well.” It should be noted that the language module 134 may generate summary contents other than those demonstrated above, evaluate the importance of the contents based on the given contents in the event aggregation report 1321, and decide contents to be displayed.

Further, the language module 134 may generate a behavior suggestion based on the event aggregation report 1321, the reference information provided by the knowledge module 133 and the behavior summary. The behavior suggestion may include one or more of the following, but is not limited to: (1) suggestion for activity in a day: “Activity level was low today, it is recommended that pet 200 has a longer walk”; (2) suggestion for notable events: “Pet 200 has vomited three times this week. It is recommended to consult a veterinarian for diagnosis”; (3) suggestion based on historical comparison: “Pet 200 drank less water today than the previous two days. It is recommended to put more water bowls”; (4) suggestion based on fundamental knowledge: “Pet 200 is 60% more active than dogs of the same breed today, be careful not to make him too tired”; (5) suggestion for user events “Pet 200 were fed too times today, be careful not to provide too many snacks”; (6) suggestion for device events: “Network connection of the first electronic device 110 was not stable today, it is recommended to reset the network connection”; (7) suggestion for environmental events: “Tomorrow will be a hot day, it is recommended to let pet 200 drink more water, and avoid outdoor activities at noon”. Specifically, the behavior summary and the behavior suggestion generated include precise events and non-precise events. In other words, the behavior summary and the behavior suggestion not only include events with predefined event types, but also include events with undefined event types and are presented in a form of natural language. Accordingly, providing pet behavior status in a more comprehensive and comprehensible manner to the users is achieved.

In an embodiment, the user equipment 140 may be a smart phone, a tablet computer, a personal digital assistant (PDA), a desktop computer, a wearable device, or other devices that can be connected to the network. The user equipment 140 may receive and display the behavior summary and/or the behavior suggestion through the network 150, and may also receive instructions from users such as asking questions, tossing snacks, etc., and these instructions will be transmitted and forwarded to first electronic device 110, the second electronic device 120, and the computing unit 130 correspondingly.

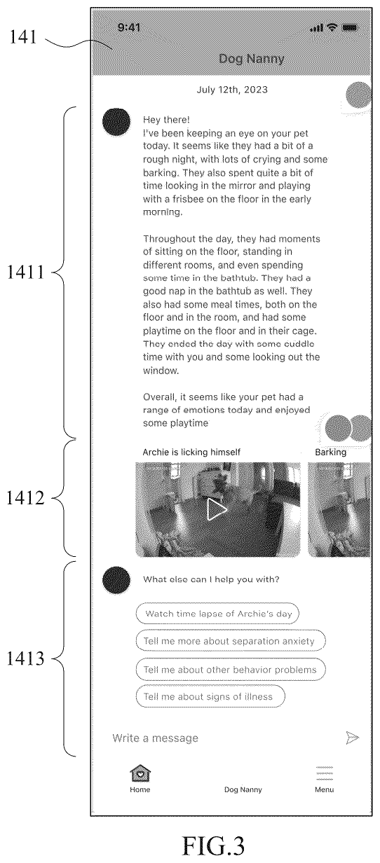

FIG. 3 is a schematic diagram of a user interface 141 of an application program of the user equipment 140 according to an embodiment of the present disclosure. The user interface 141 may at least include a text display region 1411, an image display region 1412 and an interaction region 1413. The text display region 1411 includes the behavior summary and/or the behavior suggestion. In this embodiment, the behavior summary and behavior suggestion are one-day the behavior summary and the behavior suggestion of the pet 200 in natural language. In an embodiment, both the behavior summary and the behavior suggestion are disposed in the same sub-regions of the text display area 1411. In another embodiment, the behavior summary and the behavior suggestion may be disposed in different sub-regions of the text display region 1411.

The image display area 1412 of the user interface 141 may provide relevant images of notable events for the users to watch, thereby allowing users more intuitively understanding their pet's behaviors. In an embodiment, relevant images may be selected based on the behavior summary and the behavior suggestion. For example, if the behavior summary describes dietary status of the pet 200 in the morning, an image of pet 200 eating in the morning may be provided in the image display area 1412. In an embodiment, events to be displayed from behavior events throughout the day may be, for example, an event abnormal to habits and customs of the pet 200. The pet 200 rarely barks, but barks many times today. In yet another embodiment, events to be displayed may be predefined. For example, events to be displayed may be events with notability levels higher than a preset level such as sirens, vomiting, and precise and/or non-precise events that are special, cute, impressive and so on.

In this embodiment, the interactive area 1413 in the user interface 141 may enable the user to input voices or texts to obtain further behavior status of the pet 200 or professional advices. For example, the user may input questions with respect to the contents of the behavior summary and the behavior suggestion in the interactive region 1413. For example, if the behavior summary states that “Pet 200 slept almost all the afternoon”, the user may then ask “Did pet 200 sleep well?”, if the behavior suggestion mentions “It is recommended to increase the walking time”, the user may ask “How long should I take my dog for a walk?”. In another embodiments, the user may also ask about specific behaviors of the pet 200, specific behaviors of the pet 200 during a specific period of time, request direct access to images related to specific events, etc., The questions or requests may be “What did my dog do in the morning?”, “How many times did pet 200 drink water today?”, “Did pet 200 have a good rest today?”, “Please play the videos related to the vomiting today”, “List the videos of the dog playing today”, etc. In yet another embodiment, the user may consult the system for professional advices related to pet 200 or make a request. For example, “What might be the cause of the vomiting?”, “Please recommend pet food”, etc.

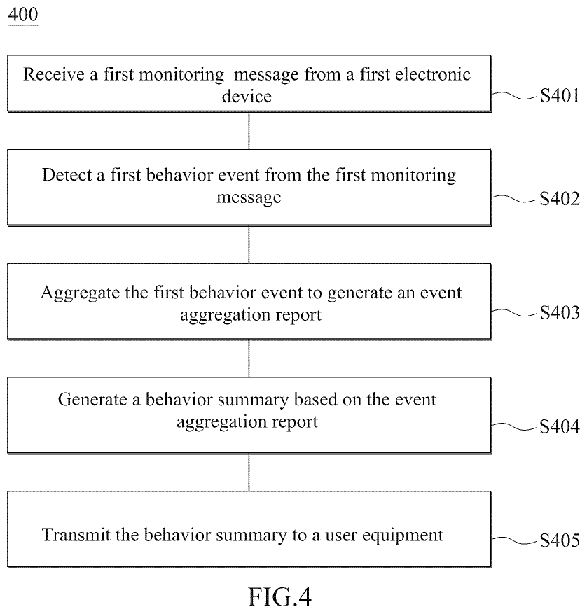

Referring to FIG. 4, a flowchart of behavior analysis method 400 is shown. In this embodiment, the behavior analysis method, executed by the computing unit 130, comprising: receiving the first monitoring message from the first electronic device 110 configured to capture image data of a scene (step S401); the artificial intelligence module 131 of the computing unit 130 detecting the first behavior event from the first monitoring message (step S402); the event aggregation module 132 of the computing unit 130 aggregating the first behavior event to generate the event aggregation report (step S403); the language model 134 of the computing unit 130 generating a behavior summary based on the event aggregation report (step S404); and transmitting the behavior summary to the user equipment 140 (step S405) for display thereon.

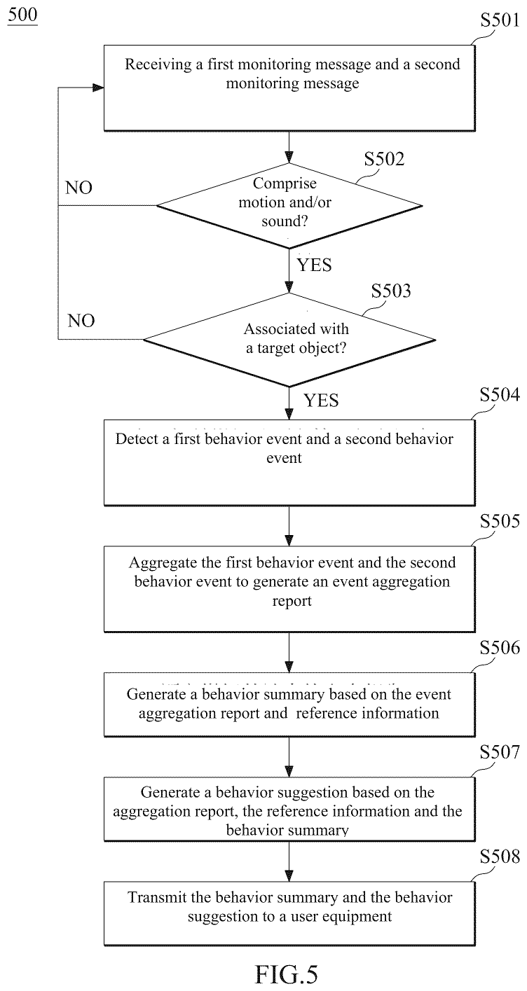

Referring to FIG. 5, a flowchart of another behavior analysis method 500 is shown. In this embodiment, receiving, by artificial intelligence module 131, the first monitoring message from the first electronic device 110 configured to capture image data of a scene, and receiving the second monitoring message from the second electronic device 120 configured to sense motion data of pet 200 (step 501). In an embodiment, the first monitoring message may further comprises video data and audio data, while the second monitoring message further comprises environmental data of an environment in which the pet 200 is located.

Determining whether the first monitoring message and the second monitoring message comprise at least one motion and/or at least one sound (step 502). In response to the determination that the first monitoring message and the second monitoring message comprise at least one motion and/or at least one sound, the first monitoring message and the second monitoring message are sent to the computing unit 130.

In response to the first monitoring message and the second monitoring message comprising at least one motion and/or at least one sound, the artificial intelligence module 131 further determines that whether the at least one motion and/or the at least one sound in the first monitoring message and the second monitoring message is associated with a target object (step 503).

In response to the at least one motion and/or the at least one sound in the first monitoring message and the second monitoring message being associated with a target object, the artificial intelligence module 131 performs behavior event detection. The artificial intelligence module 131 detects first behavior event 1311 and second behavior event 1312 from the first monitoring message and the second monitoring message, respectively (step 504).

The event aggregation module 132 aggregates the first behavior event 1311 and the second behavior event 1312 to generate the event aggregation report 1321 (step 505).

The language module 134 generates the behavior summary based on the event aggregation report 1321 and the reference information provided by the knowledge module 133 (step 506), wherein the behavior summary is in a form of natural language.

The behavior suggestion is generated based on the aggregation report 1321, the reference information and the behavior summary (step 507), wherein the behavior suggestion is a form of natural language.

The behavior summary and the behavior suggestion are transmitted to the user equipment 140 (step 508) for display thereon.

According to the above-mentioned embodiments, it can be understood that the systems and methods for behavior analysis described in the present disclosure may enable users to quickly grasp an overview the of behavior status of pets within a specific period of time, thereby saving users' time and effort spent in watching monitoring videos, automatically generating summary and corresponding suggestions in the form of natural language, and providing related video via video links. Accordingly, user experience may be improved.

It will be apparent to those skilled in the art that the present disclosure is not limited to the details of the exemplary embodiments described above, but that the present disclosure may be implemented in other specific forms without departing from the spirit or essential characteristics of the present disclosure. Therefore, no matter from any point of view, the embodiments should be regarded as exemplary and non-restrictive, and the scope of the application is defined by the appended claims rather than the above description, so it is intended to all changes within the meaning and range of equivalents of the elements are embraced in this application. Any attached reference mark in a claim shall not be deemed to limit the claim to which it relates.

Finally, it should be noted that the above embodiments are only used to illustrate the technical solutions of the present application without limitation. Although the present application has been described in detail with reference to the preferred embodiments, those skilled in the art should understand that the technical solutions of the present application can be made with modifications or equivalent replacements without departing from the spirit and scope of the technical solutions of the present application.

1. A behavior analysis system, comprising:
a first electronic device configured to capture image data of a scene to obtain a first monitoring message;
a computing unit, in communication with the first electronic device, comprising:
an artificial intelligence module configured to receive the first monitoring message and detect a first behavior event from the first monitoring message;
an event aggregation module configured to aggregate the first behavior event to generate an event aggregation report; and
a language model configured to generate a behavior summary based on the event aggregation report; and
a user equipment, in communication with the first electronic device and the computing unit, configured to display the behavior summary;
wherein the behavior summary is in a form of natural language.

2. The behavior analysis system according to claim 1, further comprising:
a second electronic device, in communication with the computing unit and the user equipment, configured to sense motion data of a pet to obtain a second monitoring message;
wherein the artificial intelligence module is configured to receive the second monitoring message and detect a second behavior event from the second monitoring message; and
the event aggregation module is configured to aggregate the first behavior event and the second behavior event to generate the event aggregation report.

3. The behavior analysis system according to claim 2, wherein the first behavior event and the second behavior event each comprise a combination of one or more precise behavior events and one or more non-precise behavior events.

4. The behavior analysis system according to claim 2, wherein:
the first electronic device is further configured to capture video data and audio data of the scene to obtain the first monitoring message; and
the second electronic device is further configured to sense environmental data of an environment in which the pet is located to obtain the second monitoring message.

5. The behavior analysis system according to claim 2, wherein the first electronic device is further configured to determine whether the first monitoring message comprises at least one motion and/or at least one sound, and the second electronic device is further configured to determine whether the second monitoring message comprises at least one motion and/or at least one sound.

6. The behavior analysis system according to claim 2, wherein the artificial intelligence module is further configured to determine whether the first monitoring message and/or the second monitoring message comprise at least one motion and/or at least one sound.

7. The behavior analysis system according to claim 5, wherein the artificial intelligence module determines whether the at least one motion and/or at least one sound in the first monitoring message and/or the second monitoring message is associated with a target object in response to the determination that the first monitoring message and/or the second monitoring message comprising the at least one motion and/or the at least one sound; and
the artificial intelligence module detects the first behavior event from the first monitoring message and detects the second behavior event from the second monitoring message in response to the determination that the at least one motion and/or at least one sound in the first monitoring message and/or the second monitoring message being associated with the target object.

8. The behavior analysis system according to claim 6, wherein the artificial intelligence module determines whether the at least one motion and/or at least one sound in the first monitoring message and/or the second monitoring message is associated with a target object in response to the determination that the first monitoring message and/or the second monitoring message comprising the at least one motion and/or the at least one sound; and
the artificial intelligence module detects the first behavior event from the first monitoring message and detects the second behavior event from the second monitoring message in response to the determination that the at least one motion and/or at least one sound in the first monitoring message and/or the second monitoring message being associated with the target object.

9. The behavior analysis system according to claim 1, the computing unit further comprising:
a knowledge module, in communication with the language module, configured to provide reference information;
wherein the language module generates the behavior summary based on the event aggregation report and the reference information.

10. The behavior analysis system according to claim 9, wherein the language module is further configured to generate a behavior suggestion based on the event aggregation report, the reference information, and the behavior summary; and the user equipment displays the behavior summary and the behavior suggestion.

11. A behavioral analysis method, executed by a computing unit, comprising:
receiving a first monitoring message from a first electronic device configured to capture image data of a scene;
detecting a first behavior event from the first monitoring message;
aggregating the first behavior event to generate an event aggregation report;
generating a behavior summary based on the event aggregation report; and
transmitting the behavior summary to a user equipment;
wherein the behavior summary is in a form of natural language.
